(19) United States
(12) Patent Application Publication
(10) Pub. No.: US 2026/0149864 A1
(43) Pub. Date: May 28, 2026

(54) CAMERA MODULE

(71) Applicant: Samsung Electro-Mechanics Co., Ltd., Suwon-si (KR)

(72) Inventors: Sang Hun HAN, Suwon-si (KR); Sung Hoon KIM, Suwon-si (KR); Kum Kyung LEE, Suwon-si (KR)

(73) Assignee: Samsung Electro-Mechanics Co., Ltd., Suwon-si (KR)

(21) Appl. No.: 19/372,687

(22) Filed: Oct. 29, 2025

(30) Foreign Application Priority Data
Nov. 25, 2024 (KR) 10-2024-0169875
May 20, 2025 (KR) 10-2025-0065581

(51) Int. Cl. H04N 23/54; G02B 13/00; G03B 5/04; G03B 13/36; G03B 30/00

(52) U.S. Cl. CPC H04N 23/54; G02B 13/0065; G03B 5/04; G03B 13/36; G03B 30/00; G03B 2205/0015; G03B 2205/0069

(57) ABSTRACT

A camera module includes a housing having an internal space; a first lens barrel and a second lens barrel each including one or more lenses disposed in a first optical axis direction; and a reflection module including a reflective member disposed at a fixed position in the internal space of the housing, wherein the first lens barrel and the second lens barrel are configured to be movable relative to the housing and the reflection module, and the second lens barrel is further configured to be movable relative to the first lens barrel.

### CROSS-REFERENCE TO RELATED APPLICATIONS

This application claims the benefit under 35 USC 119(a) of Korean Patent Application Nos. 10-2024-0169875 filed on Nov. 25, 2024, and 10-2025-0065581 filed on May 20, 2025, in the Korean Intellectual Property Office, the entire disclosures of which are incorporated herein by reference for all purposes.

### BACKGROUND

### 1. Field

The present disclosure relates to a camera module.

### 2. Description of Background

A camera module provided in a portable electronic device is being manufactured to have a thin thickness to match a thickness of the portable electronic device.

For example, the camera module provided in a portable electronic device is trending toward a folded structure, which is advantageous for implementing a thin thickness, from a conventional straight structure.

Also, a camera module provided in a portable electronic device is gradually being implemented with a high-performance.

For example, in addition to an autofocusing function and an optical image stabilization function, a camera module provided in a portable electronic device may also have a zoom function for magnifying distant objects and/or a macro function for focusing on close-up objects.

### SUMMARY

This Summary is provided to introduce a selection of concepts in simplified form that are further described below in the Detailed Description. This Summary is not intended to identify key features or essential features of the claimed subject matter, nor is it intended to be used as an aid in determining the scope of the claimed subject matter.

In one general aspect, a camera module includes a housing having an internal space; a first lens barrel and a second lens barrel each including one or more lenses disposed in a first optical axis direction; and a reflection module including a reflective member disposed at a fixed position in the internal space of the housing, wherein the first lens barrel and the second lens barrel are configured to be movable relative to the housing and the reflection module, and the second lens barrel is further configured to be movable relative to the first lens barrel.

The first lens barrel, the second lens barrel, and the reflection module may be sequentially disposed in the first optical axis direction.

The first lens barrel and the second lens barrel may be further configured to be movable relative to the reflection module in a direction perpendicular to a first optical axis, and the second lens barrel may be further configured to be movable relative to the first lens barrel and the reflection module in the first optical axis direction.

The reflective member may be configured to change a direction of light propagation from the first optical axis direction to a second optical axis direction, and the second optical axis direction may be different from the direction perpendicular to the first optical axis.

The camera module may further include an image sensor module including an image sensor having an imaging plane, wherein the image sensor module may be disposed on the housing so that the imaging plane faces the reflective member and is oblique to the first optical axis direction.

Thee image sensor module may have a long side extending in a direction perpendicular to the optical axis direction and a short side perpendicular to the long side, and a shortest distance from the first optical axis to one end of the short side of the image sensor module may be shorter than a shortest distance from the first optical axis to another end of the short side of the image sensor module.

The camera module may further include a first carrier on which the second lens barrel is disposed and configured to be movable in the first optical axis direction together with the second lens barrel; and a second carrier on which the first lens barrel is disposed and configured to be movable in the direction perpendicular to the first optical axis together with the first lens barrel, wherein the first carrier may be disposed in the second carrier and may be configured to move in the direction perpendicular to the first optical axis together with the second carrier.

The camera module may further include a cover member to which the first lens barrel is coupled, wherein the cover member may be coupled to the second carrier so that the first lens barrel is disposed on an object side of the second lens barrel.

The camera module may further include a first magnet disposed on the first carrier; and a first coil disposed on the second carrier and facing the first magnet, wherein the first magnet and the first coil may be configured to generate a driving force in the first optical axis direction.

The camera module may further include a second magnet and a third magnet disposed on the second carrier; and a second coil disposed to face the second magnet and a third coil disposed to face the third magnet, wherein the second coil and the third coil may be disposed in the housing, and the second magnet and the second coil may be configured to generate a first driving force in a first direction perpendicular to the first optical axis, and the third magnet and the third coil may be configured to generate a second driving force in a second direction perpendicular to the first optical axis.

The camera module may further include a first substrate on which the first coil is disposed; and a second substrate on which the second coil and the third coil are disposed, wherein at least a portion of the first substrate may be configured to move in the first direction perpendicular to the first optical axis together with the second carrier.

The first substrate may include a moving portion having the first coil mounted thereon and disposed on a side surface of the second carrier; a connection portion disposed on a side surface of the housing parallel to the side surface of the second carrier on which the moving portion is disposed; and an extending portion extending between the moving portion and the connection portion and including a curved portion.

In another general aspect, a camera module includes a housing having an internal space; a lens module configured to be movable in at least one direction among a direction of a first optical axis and a direction perpendicular to the first optical axis; a reflection module spaced apart from the lens module in the first optical axis direction and configured to change a direction of light incident on the reflection module in the first optical axis direction to a second optical axis direction; and an image sensor module spaced apart from the reflection module in the second optical axis direction, wherein the lens module is configured to move relative to the reflection module, and the second optical axis direction is different from the direction perpendicular to the first optical axis.

The lens module may include a first lens barrel through which light enters the camera module; and a second lens barrel disposed between the first lens barrel and the reflection module with a gap between the first lens barrel and the second lens barrel in the first optical axis direction.

The second lens barrel may be configured to move relative to the first lens barrel in the first optical axis direction, and may be configured to move in the direction perpendicular to the first optical axis together with the first lens barrel.

The reflection module may be disposed on a bottom surface of the housing, and a portion of the reflection module may overlap the bottom surface of the housing in the first optical axis direction.

Other features and aspects will be apparent from the following detailed description, the drawings, and the claims.

### BRIEF DESCRIPTION OF DRAWINGS

FIG. 1 is a perspective view of a camera module according to an embodiment of the present disclosure.

FIG. 2 is a cross-sectional view of the camera module of FIG. 1 taken along the line II-II′ in FIG. 1.

FIG. 3 is an exploded perspective view of the camera module of FIGS. 1 and 2.

FIG. 4 is an exploded perspective view of a housing and an image sensor module of the camera module of FIGS. 1 and 2.

FIG. 5 is an exploded perspective view of components related to an autofocusing function of a camera module according to an embodiment of the present disclosure.

FIG. 6 is a perspective view of FIG. 1 with a shield can removed.

FIG. 7 is an exploded perspective view of components related to an optical image stabilization function of a camera module according to an embodiment of the present disclosure.

FIG. 8A is a cross-sectional view taken along the line VIIIA-VIIIA′ in FIG. 6.

FIG. 8B is a cross-sectional view taken along the line VIIIB-VIIIB′ in FIG. 6.

FIG. 9 is a perspective view of a first substrate mounting state according to an embodiment of the present disclosure.

FIG. 10 is a perspective view of a first substrate of FIG. 9.

FIG. 11 is a plan view of FIG. 9.

FIG. 12 is a cross-sectional view taken along the line XII-XII′ in FIG. 9.

FIGS. 13 and 14 are schematic diagrams of camera modules according to modified embodiments of the present disclosure.

Throughout the drawings and the detailed description, the same reference numerals refer to the same elements. The drawings may not be to scale, and the relative sizes, proportions, and depictions of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated by 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

The present disclosure relates to a camera module, and more particularly, to a camera module provided in a portable electronic device. The portable electronic device may be, for example, a smart phone, a tablet PC, a laptop, or any other type of portable electronic device, and a type of the portable electronic device is not limited. The camera module of the present disclosure may have a high-magnification close-up function when provided in a portable electronic device.

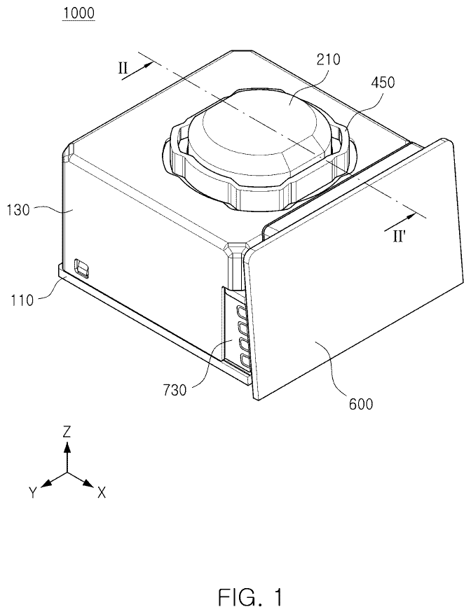

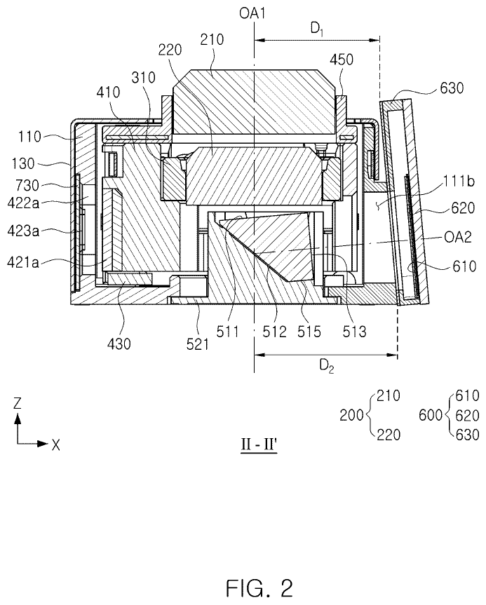

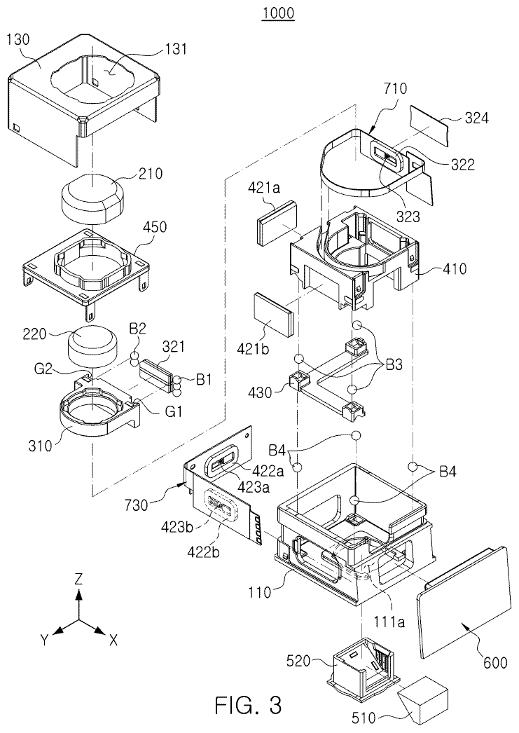

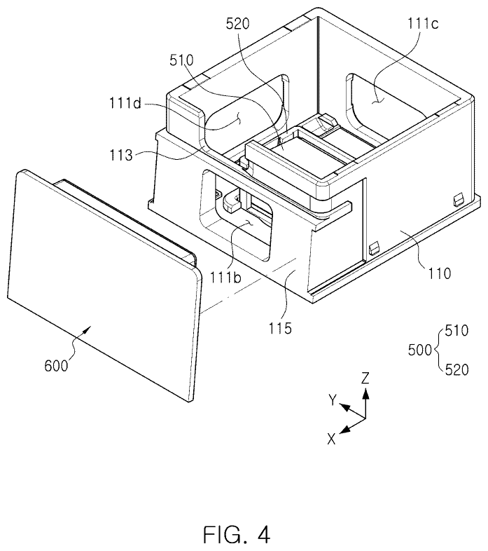

FIG. 1 is a perspective view of a camera module according to an embodiment of the present disclosure, FIG. 2 is a cross-sectional view of the camera module of FIG. 1 taken along the line II-II′ in FIG. 1, FIG. 3 is an exploded perspective view of the camera module of FIGS. 1 and 2, and FIG. 4 is an exploded perspective view of a housing and an image sensor module of the camera module of FIGS. 1 and 2.

Referring to FIG. 1, a housing 110 and a shield can 130 form an exterior of a camera module 1000. The shield can 130 is coupled to the housing 110 on an object side of the housing 110.

The housing 110 is provided with a space for accommodating components of the camera module 1000, and the shield can 130 covers the space to protect the components.

The shield can 130 is provided with an opening 131, and a lens barrel (hereinafter, a first lens barrel 210) is disposed in the opening 131. The first lens barrel 210 is exposed externally through the opening 131 so that light can be incident on the first lens barrel 210.

Referring further to FIG. 2, various types of optical modules, including a lens module 200 and a reflection module 500, are disposed in the housing 110, and an image sensor module 600 is attached to the housing 110.

The lens module 200, the reflection module 500, and the image sensor module 600 are disposed sequentially along a path of propagation of light. Light incident on the lens module 200 is reflected by the reflection module 500 and reaches the image sensor module 600.

The lens module 200 includes a plurality of lenses refracting light. The plurality of lenses are stacked in an optical axis direction (a Z-axis direction), and are divided and disposed in the first lens barrel 210 and a second lens barrel 220.

The reflection module 500 is spaced apart from the lens module 200 in the optical axis direction (Z-axis direction). The reflection module 500 includes a reflective member 510 reflecting light, for example, a prism.

The reflective member 510 increases a total track length and a focal length of the camera module 1000 by bending a direction of propagation of light.

The camera module 1000 has two optical axes, for example, a first optical axis (OA1) and a second optical axis (OA2), as a result of having a reflective member 510. Hereinafter, the optical axis (Z-axis) parallel to the direction of incidence of light is defined as a first optical axis (OA1), and the optical axis changed by the reflective member 510 is defined as a second optical axis (OA2).

The image sensor module 600 includes an image sensor 610 converting light into an electrical signal. The image sensor 610 is disposed to face a reflective member 510 through which light is incident. An imaging plane of the image sensor 610 is disposed to face the reflective member 510 in a second optical axis (OA2) direction. Therefore, light emitted from the reflective member 510 may be incident on the imaging plane of the image sensor 610 and converted into an electrical signal.

The housing 110 is provided in a square box shape having a space formed therein. The space of the housing 110 is defined by a bottom surface and four side surfaces extending from the bottom surface in a first optical axis (OA1) direction. That is, there is no surface facing the bottom surface, and the housing 110 is completely open to the object side.

A reflection module 500 is coupled to the bottom surface of the housing 110.

The reflection module 500 includes a reflective member (hereinafter, a prism 510) and a holder (hereinafter, a prism holder 520) on which the prism 510 is mounted.

The prism 510 includes an incident surface 511 facing approximately in the first optical axis (OA1) direction with respect to the lens module 200, an emission surface 513 facing approximately in the second optical axis (OA2) direction with respect to the image sensor 610, and a reflective surface 512 disposed at an angle with respect to the incident surface 511 and the emission surface 513. In addition, the prism 510 includes two side surfaces that meet the incident surface 511, the reflective surface 512, and the emission surface 513 and are parallel to each other.

Furthermore, the prism 510 may be provided in a form in which one edge is chamfered. A chamfered surface 515 formed by chamfering instead of a sharp edge is provided between the reflective surface 512 and the emission surface 513. The reflective surface 512 and the emission surface 513 are separated by the chamfered surface 515. The risk of damage to the prism 510 may be reduced by providing the chamfered surface 515.

The prism 510 is mounted on the prism holder 520. The prism holder 520 includes a mounting surface on which the reflective surface 512 of the prism 510 is mounted and a cover portion on which the two side surfaces of the prism 510 are supported, and has an open shape along the path of propagation of light so as not to obstruct the propagation of light.

The prism holder 520 includes a flange portion 521 coupled to a bottom surface of the housing 110. The bottom surface of the housing 110 and the flange portion 521 have a structure that can be mechanically coupled.

The reflection module 500 is assembled into the housing 110 while the prism 510 is mounted on the prism holder 520. The reflection module 500 is assembled into the bottom surface of the housing 110 by being moved in the first optical axis (OA1) direction while being located below the bottom surface of the housing 110.

A through-hole 111a is provided in the bottom surface of the housing 110. A portion of the reflection module 500, including the prism 510, passes through the through-hole 111a and is disposed in the internal space of the housing 110, and the flange portion 521 of the prism holder 520 is coupled to the bottom surface of the housing 110 around the through-hole 111a. The flange portion 521 overlaps the bottom surface of the housing 110 in the first optical axis (OA1) direction.

The through-hole 111a is provided at a position facing the opening 131 of the shield can 130 in the first optical axis (OA1) direction, and the prism 510 may be aligned with the lenses of the first lens barrel 210 and the second lens barrel 220 and the optical axis OA1.

The image sensor module 600 is coupled to one side surface of the housing 110.

The image sensor module 600 includes an image sensor 610, a printed circuit board (hereinafter, a sensor substrate 620), and a sub-housing 630.

The image sensor 610 is mounted on the sensor substrate 620, and is electrically connected to the sensor substrate 620.

The sensor substrate 620 with the image sensor 610 mounted thereon is coupled to the sub-housing 630, and the sub-housing 630 is coupled to one side surface of the housing 110. That is, the image sensor 610 and the sensor substrate 620 are coupled to the housing 110 via the sub-housing 630.

A through-hole 111b is provided in one side surface of the housing 110, and the sub-housing 630 includes an opening 631 at a position corresponding to the through-hole 111b. The image sensor 610 faces the opening 631.

The image sensor module 600 has a long side and a short side, and the image sensor module 600 is coupled to the housing 110 so that the short side roughly corresponds to a thickness direction of the camera module 1000.

One side surface of the housing 110 to which the image sensor module 600 is coupled is an inclined surface 115, oblique to the first optical axis (OA1), and the image sensor module 600 is coupled to the housing 110 to be oblique to the first optical axis (OA1), for example, so that the short side of the image sensor module 600 is not parallel to the first optical axis (OA1). Therefore, a shortest distance (D1) from the first optical axis (OA1) to one end of the short side of the image sensor module 600 is shorter than a shortest distance (D2) from the first optical axis (OA1) to the other end of the short side of the image sensor module 600.

Because the image sensor module 600 is obliquely coupled to the housing 110, a thickness of the camera module 1000 in the first optical axis (OA1) direction may be reduced. In detail, because the thickness of the camera module 1000 in the first optical axis (OA1) direction corresponds to a thickness of the portable electronic device, the portable electronic device may be manufactured to have a slimmer thickness because the thickness of the camera module 1000 in the first optical axis (OA1) direction is reduced.

The inclined surface 115 oblique to the first optical axis (OA1) to which the image sensor module 600 is coupled may be a separate member coupled to one side surface of the housing 110, or may be a portion of the housing 110. For example, the inclined surface 115 may be formed at a protruding position on one side surface of the housing 110.

The prism 510 is disposed obliquely with respect to the first optical axis (OA1) so that light emitted from the prism 510 may be incident on a center of the imaging plane of the image sensor 610. For example, a center of the reflective surface 512 is located on the first optical axis (OA1) and the second optical axis (OA2), while the incident surface 511 of the prism 510 is disposed obliquely with respect to the first optical axis (OA1).

According to the above-described embodiment, the first optical axis (OA1) and the second optical axis (OA2) are not perpendicular to each other. Therefore, the second optical axis (OA2) direction is not parallel to a first direction (X-direction) or a second direction (Y-direction) in which the lens module 200 moves during optical image stabilization of a camera module 1000 to be described below.

However, in another embodiment, the image sensor module 600 may be disposed in the housing so that the imaging plane of the image sensor 610 is parallel to the first optical axis (OA1) and perpendicular to the second optical axis (OA2).

The prism 510 has an incident surface 511 perpendicular to the first optical axis (OA1) and an emission surface 513 perpendicular to the second optical axis (OA2), and changes a direction of light incident on the camera module 1000 from a first optical axis (OA1) direction to a second optical axis (OA2) direction.

In this case, the first optical axis (OA1) and the second optical axis (OA2) are perpendicular to each other. In addition, the direction of the second optical axis (OA2) is parallel to the first direction (X-direction) or the second direction (Y-direction) in which the lens module 200 and other components move during optical image stabilization of the camera module 1000 to be described below.

The lens module 200 includes the first lens barrel 210 and the second lens barrel 220 sequentially disposed in the first optical axis (OA1) direction.

Each of the first lens barrel 210 and the second lens barrel 220 is provided with one or more lenses sequentially disposed in the first optical axis (OA1) direction.

The first lens barrel 210 and the second lens barrel 220 are coupled to different components. The first lens barrel 210 is coupled to a cover member 450, and the second lens barrel 220 is coupled to a first carrier 310.

In more detail, the first lens barrel 210 is coupled to the cover member 450 and moves in a direction perpendicular to the first optical axis (OA1) together with the cover member 450, and does not move in the first optical axis (OA1) direction. The second lens barrel 220 is coupled to the first carrier 310 and moves together with the first carrier 310 in the first optical axis (OA1) direction and in a direction perpendicular to the first optical axis (OA1).

That is, during optical image stabilization, both the first lens barrel 210 and the second lens barrel 220 are moving members, but during autofocusing, the first lens barrel 210 is a fixed member, and the second lens barrel 220 is a moving member.

During autofocusing, the second lens barrel 220 may move in the first optical axis (OA1) direction relative to the first lens barrel 210 so that a distance in the first optical axis (OA1) direction between the second lens barrel 220 and the first lens barrel 210 changes. Similarly, as the second lens barrel 220 moves in the first optical axis (OA1) direction, a distance in the first optical axis (OA1) direction between the second lens barrel 220 and the prism 510 also changes.

As described above, the focal length of the camera module 1000 may be changed as a distance between optical members changes due to the movement of the second lens barrel 220 in the first optical axis (OA1) direction.

In particular, as the second lens barrel 220 moves toward the first lens barrel 210, in other words, as a distance from a lens disposed on the uppermost side among one or more lenses disposed in the second lens barrel 220 to an imaging plane of the image sensor 610 increases, a close-up function that can focus on and capture a subject at a close range may be implemented.

The camera module 1000 is provided with an autofocusing function and an optical image stabilization function.

The autofocusing function is implemented by the movement of the second lens barrel 220 in the first optical axis (OA1) direction, and the optical image stabilization function is implemented by the movement of the first lens barrel 210 and the second lens barrel 220 in the first direction (X-direction) and the second direction (Y-direction) perpendicular to the first optical axis (OA1) direction. The first direction (X-direction) and the second direction (Y-direction) are also perpendicular to each other.

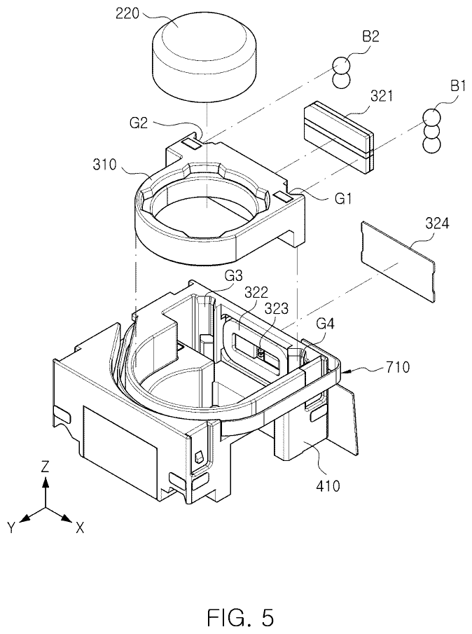

FIG. 5 is an exploded perspective view of components related to an autofocusing function of a camera module according to an embodiment of the present disclosure.

The second lens barrel 220 is coupled to the first carrier 310 while being accommodated in the first carrier 310. The first carrier 310 is supported by a second carrier 410 with a first ball member B1 and a second ball member B2 interposed therebetween while being accommodated in the second carrier 410.

The first ball member B1 and the second ball member B2 are inserted between the first carrier 310 and the second carrier 410 and roll in the first optical axis (OA1) direction, and the first carrier 310 moves in the first optical axis (OA1) direction relative to the second carrier 410 by riding on the first ball member B1 and the second ball member B2 as the first ball member B1 and the second ball member B2 roll in the first optical axis (OA1) direction. The first ball member B1 and the second ball member B2 serve to reduce friction between the first carrier 310 and the second carrier 410 when the first carrier 310 moves relative to the second carrier 410.

The first ball member B1 and the second ball member B2 are disposed between one side surface of the first carrier 310 and one side surface of the second carrier 410 facing each other in a direction perpendicular to the first optical axis (OA1), for example, in the second direction (Y-direction). The first ball member B1 and the second ball member B2 are spaced apart from each other in a direction perpendicular to the first optical axis (OA1), for example, in the first direction (X-direction).

One side surface of the first carrier 310 and one side surface of the second carrier 410 facing each other are provided with guide grooves for accommodating the first ball member B1 and the second ball member B2. For example, one side surface of the first carrier 310 is provided with a first guide groove G1 and a second guide groove G2, and one side surface of the second carrier 410 facing the one side surface of the first carrier 310 is provided with a third guide groove G3 facing the first guide groove G1 and a fourth guide groove G4 facing the second guide groove G2. The first ball member B1 is inserted between the first guide groove G1 and the third guide groove G3, and the second ball member B2 is inserted between the second guide groove G2 and the fourth guide groove G4.

The first to fourth guide grooves G1, G2, G3, and G4 have a length in the first optical axis (OA1) direction to guide a rolling movement of the first ball member B1 and the second ball member B2 in the first optical axis (OA1) direction. In addition, at least a portion of the first to fourth guide grooves G1, G2, G3, and G4 have a shape contacting the first ball member B1 and the second ball member B2 at two points, thereby limiting the rolling movement direction of the first ball member B1 and the second ball member B2 to the first optical axis (OA1) direction.

The camera module 1000 is provided with a driving unit (hereinafter, “a first driving unit”) providing a driving force to move the second lens barrel 220 and the first carrier 310 in the first optical axis (OA1) direction.

The first driving unit includes a first magnet 321, and a first coil 322 disposed to face the first magnet 321.

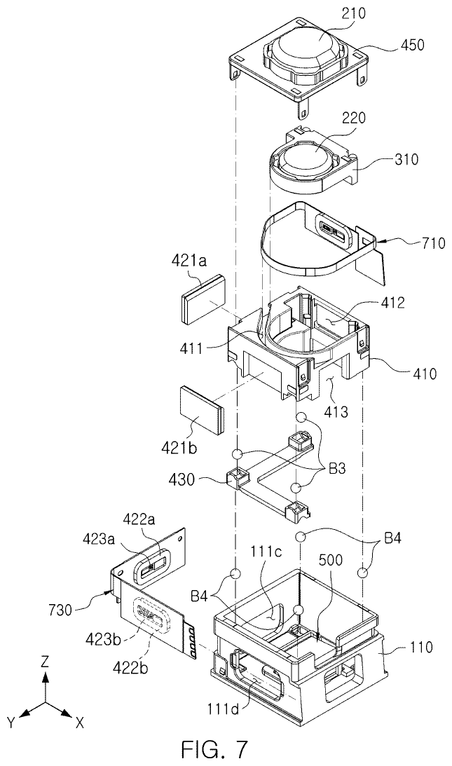

The first magnet 321 is disposed on one side surface of the first carrier 310, for example, between the first ball member B1 and the second ball member B2, and the first coil 322 is disposed on one side surface of the second carrier 410. The first coil 322 is disposed on one side surface of the second carrier 410 via a substrate (hereinafter, a first substrate 710). A first through-hole 412 (see FIG. 7) is provided in one side surface of the second carrier 410, and the first coil 322 directly faces the first magnet 321 through the first through-hole 412.

When power is applied to the first coil 322, the first magnet 321 and the first coil 322 generate a driving force in the first optical axis (OA1) direction. Since the first magnet 321 is disposed on the first carrier 310, the first magnet 321 moves in the first optical axis (OA1) direction in response to the driving force generated by the first driving unit. On the other hand, since the first coil 322 is disposed on the second carrier 410, the first coil 322 does not move in the first optical axis (OA1) direction. That is, during autofocusing, the first magnet 321 is a moving member, and the first coil 322 is a fixed member.

A first position sensor 323 for detecting a position of the second lens barrel 220 in the first optical axis (OA1) direction is disposed on the first substrate 710 together with the first coil 322. The first position sensor 323 is disposed on the same surface of the first substrate 710 as the first coil 322.

The first position sensor 323 is disposed to face the first magnet 321 and detects a change in a magnetic field generated by the first magnet 321 to detect the position of the second lens barrel 220 in the first optical axis (OA1) direction.

In addition, a first yoke 324 is disposed on one side surface of the second carrier 410. The first yoke 324 is disposed to cover an outer surface of the first substrate 710, and faces the first magnet 321 with the first coil 322 and the first position sensor 323 interposed therebetween.

The first yoke 324 is provided with a magnetic body to generate a magnetic attraction with the first magnet 321. For example, the first yoke 324 and first magnet 321 face each other in the second direction (Y-direction), and generate a magnetic attraction in the second direction (Y-direction).

One side surface of the first carrier 310 is pulled toward one side surface of the second carrier 410 by the magnetic attraction between the first yoke 324 and the first magnet 321. Therefore, the first ball member B1 and the second ball member B2 may held in place between the one side surface of the first carrier 310 and the one side surface of the second carrier 410.

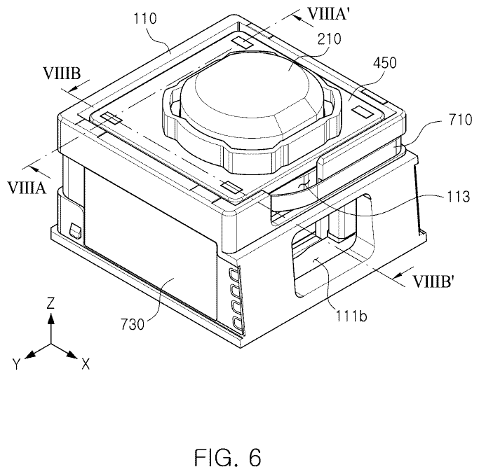

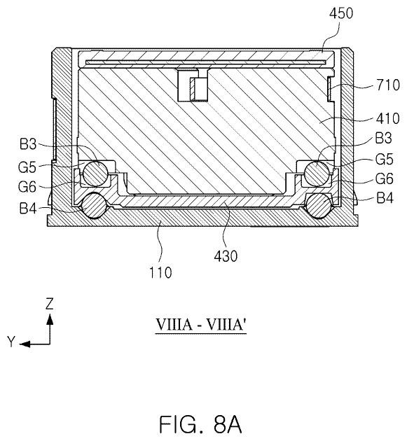

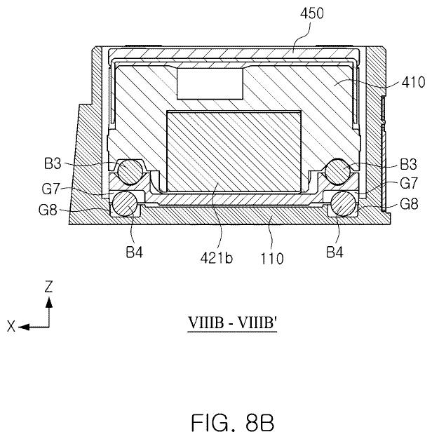

FIG. 6 is a perspective view of FIG. 1 with a shield can removed, FIG. 7 is an exploded perspective view of components related to an optical stabilization function of a camera module according to an embodiment of the present disclosure, FIG. 8A is a cross-sectional view taken along the line VIIIA-VIIIA′ in FIG. 6, and FIG. 8B is a cross-sectional view taken along the line VIIIB-VIIIB′ in FIG. 6.

A camera module 1000 includes a guide frame 430 disposed between a second carrier 410 and a housing 110.

A first lens barrel 210 is coupled to the second carrier 410. In detail, the first lens barrel 210 is coupled to a cover member 450 coupled to the second carrier 410.

The second carrier 410 has an opening in a first optical axis (OA1) direction so that the first carrier 310 moves in the first optical axis (OA1) direction while being accommodated in the second carrier 410, and the cover member 450 is coupled to the second carrier 410 on an object side thereof. The cover member 450 covers the opening in the second carrier 410 on the object side to prevent the separation of the components accommodated in the second carrier 410.

A second magnet 421a and a third magnet 421b, to be described later, are disposed on two side surfaces of the second carrier 410 perpendicular to each other, and through-holes (hereinafter, a first through-hole 412 and a second through-hole 413) are provided in the remaining two side surfaces thereof.

The first magnet 321 and the first coil 322 face each other directly through the first through-hole 412 provided in the second carrier 410, and the prism 510 and the image sensor 610 face each other through the second through-hole 413 provided in the second carrier 413. That is, the second through-hole 413 is provided at a position corresponding to the through-hole 111b provided in one side surface of the housing 110 to which the image sensor module 600 is coupled.

The second carrier 410, the guide frame 430, and the housing 110 are sequentially disposed in the first optical axis (OA1) direction. The second carrier 410 is supported by the guide frame 430 with a third ball member B3 interposed therebetween, and the guide frame 430 is supported by the housing 110 with a fourth ball member B4 interposed therebetween.

The third ball member B3 is inserted between the second carrier 410 and the guide frame 430 and rolls in a first direction (X-direction), and the second carrier 410 moves relative to the guide frame 430 and the housing 110 in the first direction (X-direction). The fourth ball member B4 is inserted between the guide frame 430 and the housing 110 and rolls in a second direction (Y-direction), and the guide frame 430 moves relative to the housing 110 in the second direction (Y-direction).

Since the second carrier 410 is supported by the guide frame 430, the second carrier 410 moves in the second direction (Y-direction) together with the guide frame 430. That is, the second carrier 410 moves in the first direction (X-direction) and the second direction (Y-direction).

Since the cover member 450 is coupled to the second carrier 410, and the first carrier 310 is supported, the cover member 450 and the first carrier 310 move together with the second carrier 410.

In addition, since a first lens barrel 210 is coupled to the cover member 450, and a second lens barrel 220 is coupled to the first carrier 310, the first lens barrel 210 and the second lens barrel 220 move together with the second carrier 450. Therefore, optical axes of the first lens barrel 210 and the second lens barrel 220 are always aligned without separation.

The third ball member B3 and the fourth ball member B4 each include three or more balls. For example, the third ball member B3 includes three balls, and the fourth ball member B4 includes four balls. The guide frame 430 has a shape connecting three corners, for example, a ‘┐’ shape, and the three balls of the third ball member B3 are disposed at the three corners.

The third ball member B3 serves to reduce friction when the second carrier 410 moves relative to the guide frame 430.

The third ball member B3 is disposed between one surface of the second carrier 410 and one surface of the guide frame 430 facing each other in the first optical axis (OA1) direction. A gap is maintained between the second carrier 410 and the guide frame 430 in the first optical axis (OA1) direction by the third ball member B3.

One surface of the second carrier 410 and one surface of the guide frame 430 facing each other in the first optical axis (OA1) direction are provided with grooves for accommodating the third ball member B3. For example, the second carrier 410 is provided with a fifth guide groove G5, and the guide frame 430 is provided with a sixth guide groove G6 facing the fifth guide groove G5.

The fifth guide groove G5 and the sixth guide groove G6 have a length extending in the first direction (X-direction) to guide a rolling movement direction of the third ball member B3. In addition, the fifth guide groove G5 and the sixth guide groove G6 have a shape contacting the third ball member B3 at two points, thereby limiting the rolling movement direction of the third ball member B3.

The fourth ball member B4 serves to reduce friction when the guide frame 430 moves relative to the housing 110.

The fourth ball member B4 is disposed between one surface of the guide frame 430 and one surface of the housing 110 facing each other in the first optical axis (OA1) direction. A gap is maintained between the guide frame 430 and the housing 110 in the first optical axis (OA1) direction by the fourth ball member B4.

One surface of the guide frame 430 and one surface of the housing 110 facing each other in the first optical axis (OA1) direction are provided with grooves for accommodating a fourth ball member B4. For example, the guide frame 430 is provided with a seventh guide groove G7, and the housing 110 is provided with an eighth guide groove G8 facing the seventh guide groove G7.

The seventh guide groove G7 and the eighth guide groove G8 have a length extending in the second direction (Y-direction) to guide a rolling movement direction of the fourth ball member B4. In addition, the seventh guide groove G7 and the eighth guide groove G8 have a shape contacting the fourth ball member B4 at two points, thereby limiting the rolling movement direction of the fourth ball member B4.

The camera module 1000 is provided with a driving unit (hereinafter, a second driving unit) providing a driving force to move the first lens barrel 210 and the second carrier 410 in the first direction (X-direction) and the second direction (Y-direction).

The second driving unit includes a second magnet 421a, a second coil 422a disposed to face the second magnet 421a, a third magnet 421b, and a third coil 422b disposed to face the third magnet 421b.

The second magnet 421a and the third magnet 421b are disposed on two vertical side surfaces of the second carrier 410. The second coil 422a and the third coil 422b are disposed on two vertical side surfaces of the housing 110. The second coil 422a and the third coil 422b are disposed in the housing 110 via a substrate (hereinafter, a second substrate 730). The second substrate 730 is disposed to be bent in some portions, and is disposed across two vertical side surfaces of the housing 110. The two vertical side surfaces of the housing 110 are provided with through-holes 111c and 111d, and the third coil 422a and the third coil 422b directly face the second magnet 421a and the third magnet 421b through the through-holes 111c and 111d, respectively.

The second magnet 421a and the second coil 422a face each other in the first direction (X-direction), and generate a driving force in the first direction (X-direction). The third magnet 421b and the third coil 422b face each other in the second direction (Y-direction), and generate a driving force in the second direction (Y-direction).

Since the second magnet 421a and the third magnet 421b are disposed on the second carrier 410, the second magnet 421a and the third magnet 421b move in the first direction (X-direction) and the second direction (Y-direction) in response to the driving forces generated by the second driving unit. On the other hand, since the second coil 422a and the third coil 422b are disposed in the housing 110, the second coil 422a and the third coil 422b do not move in the first direction (X-direction) and the second direction (Y-direction). That is, during optical image stabilization, the second magnet 421a and the third magnet 421b are moving members, and the second coil 422a and the third coil 422b are fixed members.

A second position sensor 423a and a third position sensor 423b for detecting a position of the lens module 200 perpendicular to the first optical axis (OA1) are disposed on the second substrate 730 together with the second coil 422a and the third coil 422b. The second position sensor 423a is disposed on the same surface of the second substate 730 as the second coil 422a, and the third position sensor 423b is disposed on the same surface of the second substrate 730 as the third coil 422b.

The second position sensor 423a and the third position sensor 423b are disposed to face the second magnet 421a and the third magnet 421b, respectively, and detect changes in magnetic fields generated by the second magnet 421a and the third magnet 421b to detect a position of the lens module 200 in a direction perpendicular to the first optical axis (OA1).

In addition, a pulling yoke (not shown) is further disposed on a surface facing the second carrier 410 of the housing 110 in the first optical axis (OA1) direction. For example, the pulling yoke is disposed on two vertical edges of the housing 110 to face the second magnet 421a and the second magnet 421b disposed on the second carrier 410, respectively.

The pulling yoke is provided with a magnetic body and generates a magnetic attraction with the second magnet 421a and the third magnet 421b in the first optical axis (OA1) direction.

The second carrier 410 is pulled toward the housing 110 in the first optical axis (OA1) direction by the magnetic attraction generated between the pulling yoke and the second magnet 421a and the third magnet 421b. Therefore, the third ball member B3 may be held in place between the second carrier 410 and the guide frame 430, and the fourth ball member B4 may b held in place between the guide frame 430 and the housing 110.

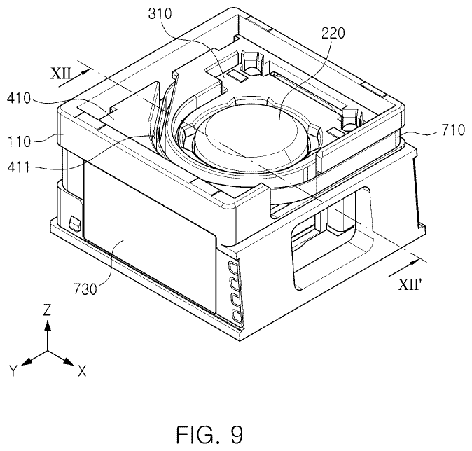

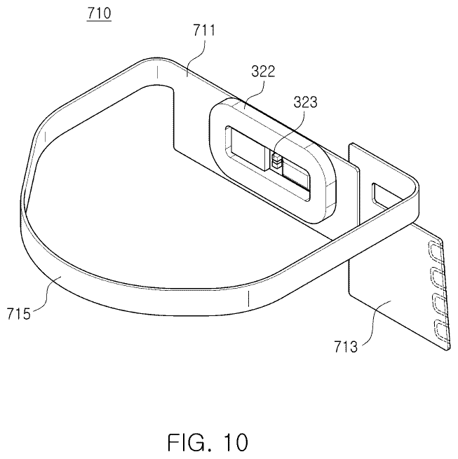

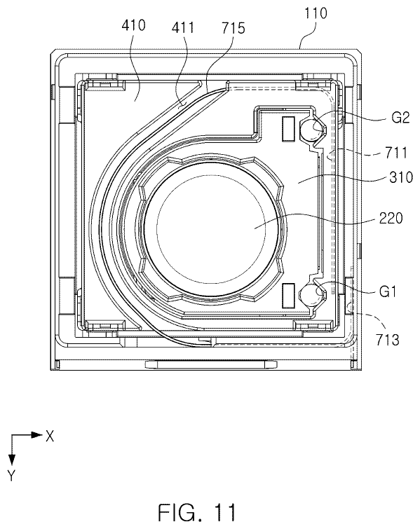

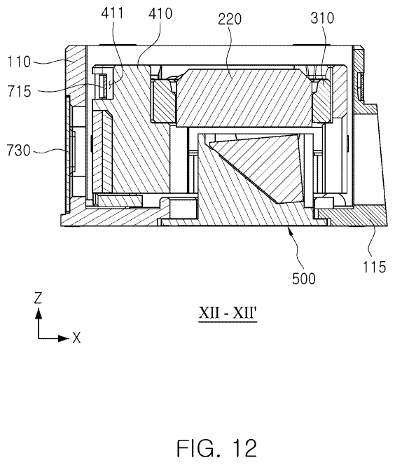

FIG. 9 is a perspective view of a first substrate mounting state according to an embodiment of the present disclosure, FIG. 10 is a perspective view of a first substrate of FIG. 9, FIG. 11 is a plan view of FIG. 9, and FIG. 12 is a cross-sectional view taken along the line XII-XII′ in FIG. 9.

Referring to FIG. 9, a portion of a first substrate 710, for example, a portion (hereinafter referred to as a moving portion 711) on which a first coil 322 and a first position sensor 323 are disposed, is disposed on a second carrier 410, and another portion of the first substrate 710, for example, a portion (hereinafter referred to as a connection portion 713) provided with a connection pad electrically connected to the sensor substrate 620, is disposed on the housing 110.

During optical image stabilization, the moving portion 711 of the first substrate 710 moves in a first direction (X-direction) and a second direction (Y-direction) together with the second carrier 410 while the connection portion 713 of the first substrate 710 is disposed on the housing 110.

Accordingly, the first substrate 710 has a structure that can support the movement of the second carrier 410 during optical image stabilization. The first substrate 710 includes an extending portion 715 extending between the moving portion 711 and the connection portion 713 and connecting the moving portion 711 and the connection portion 713 to each other. The extending portion 715 may minimize a tension applied to the first substrate 710 while moving together with the second carrier 410.

The moving portion 711 of the first substrate 710 is disposed on one side surface of the second carrier 410, and the connection portion 713 is disposed on one side surface of the housing 110 parallel to one side surface of the second carrier 410.

The extending portion 715 extends to wrap around the second carrier 410 once between the moving portion 711 and the connection portion 713.

An upper surface of the second carrier 410 is provided with a groove portion 411 into which the extending portion 715 is inserted. The groove portion 411 is formed along a peripheral portion of an opening of the second carrier 410. For example, the opening of the second carrier 410 has a partially rounded shape, and the groove portion 411 is formed around the opening along the shape of the opening.

A portion of the extending portion 715 is disposed in the groove portion 411. A portion of the extending portion 715 has a curved shape, thereby having a shape corresponding to the groove portion 411, and is disposed in the groove portion 411 with a gap between two side surfaces defining the groove portion 411.

The housing 110 is provided with an avoidance groove 113 (see FIG. 6) through which the extending portion 715 that wraps around the second carrier 410 once passes. The avoidance groove 113 is provided in a side surface of the housing adjacent to a side surface of the housing 110 on which the connection portion 713 is disposed. For example, the side surface of the housing 110 provided with the avoidance groove 113 may be perpendicular to the side surface of the housing 110 on which the connection portion 713 is disposed, and may be a surface to which the image sensor module 600 is coupled. The extending portion 715 passes through the avoidance groove 113 and is spaced apart from the side surface of the housing 110 in which the avoidance groove 113 is provided.

According to an embodiment of the present disclosure, a lens module 200 is movably disposed in a housing 110. The lens module 200 includes a second lens barrel 220 that moves both during autofocusing and optical image stabilization, and a first lens barrel 210 that moves only during optical image stabilization. That is, the second lens barrel 220 moves relative to the first lens barrel 210 during autofocusing.

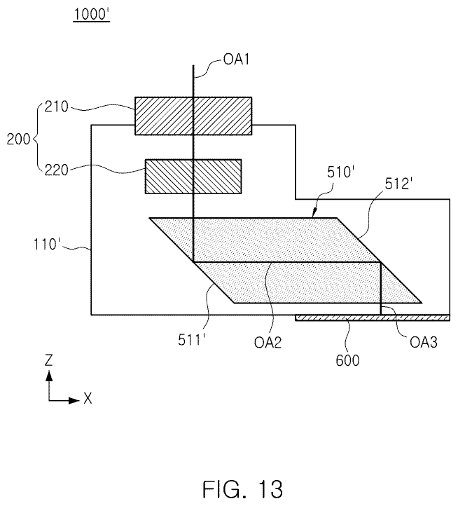

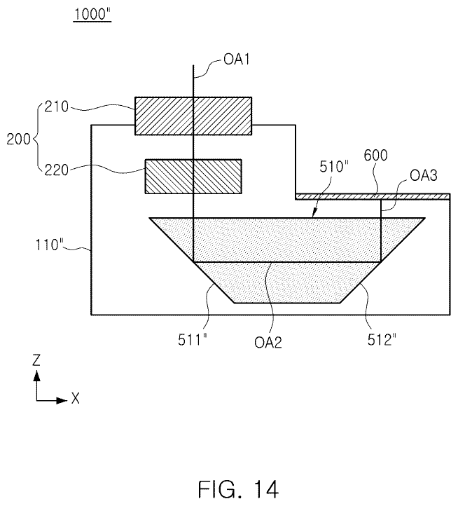

The reflection module 500 is fixedly disposed in the housing 110. The lens module 200 moves relative to the reflection module 500 during autofocusing and optical image stabilization. The present disclosure may be implemented in a modified form as shown in FIG. 13 and FIG. 14 while maintaining this structure.

FIGS. 13 and 14 are schematic diagrams of a camera module according to modified embodiments of the present disclosure.

Referring to FIGS. 13 and 14, camera modules 1000′ and 1000″ includes reflective members 510′ and 510″ of different types that the reflection module 500 in the above-described embodiments, and accordingly, a position at which an image sensor module 600 is disposed may also be changed.

For example, the reflective members 510′ and 510″ may be provided as a prism having two or more reflective surfaces. Accordingly, a path of propagation of light is further extended, which may be advantageous in implementing a high magnification.

Referring to FIG. 13, the reflective member 510′ may be provided as a parallelogram prism having two reflective surfaces parallel to each other. Alternatively, as shown in FIG. 14, the reflective member 510″ may be provided as a trapezoidal prism having two reflective surfaces symmetrically disposed with respect to a direction parallel to the first optical axis (OA1).

First reflective surfaces 511′and 511″ can change a direction of propagation of light from a first optical axis (OA1) direction to a second optical axis (OA2) direction approximately perpendicular to a first optical axis (OA1) direction, and second reflective surfaces 512′and 512″ may change the direction of propagation of light from the direction of the second optical axis (OA2) back to a direction parallel to the first optical axis (OA1), for example, a direction of a third optical axis (OA3).

According to the modified embodiments of FIGS. 13 and 14, housings 110′and 110″ have a shape that is elongated in one direction compared to the housing 110 in the above-described embodiments. Furthermore, the image sensor module 600 is coupled to the housings 110′and 110″ in a lying state, so the thickness of the camera module 1000 is less affected by the size of the image sensor 610. For example, the image sensor module 600 may be disposed in the housings 110′and 110″ so that the imaging plane of the image sensor 610 is perpendicular to the first optical axis (OA1) direction.

As set forth above, according to an embodiment of the present disclosure, a camera module is capable of high-magnification close-up photography.

While this disclosure includes specific embodiments, it will be apparent after an understanding of the disclosure of this application that various changes in form and details may be made in these embodiments without departing from the spirit and scope of the claims and their equivalents. Descriptions of features or aspects in each embodiment are to be considered as being applicable to similar features or aspects in other embodiments. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A camera module comprising:
a housing having an internal space;
a first lens barrel and a second lens barrel each comprising one or more lenses disposed in a first optical axis direction; and
a reflection module comprising a reflective member disposed at a fixed position in the internal space of the housing,
wherein the first lens barrel and the second lens barrel are configured to be movable relative to the housing and the reflection module, and
the second lens barrel is further configured to be movable relative to the first lens barrel.

2. The camera module of claim 1, wherein the first lens barrel, the second lens barrel, and the reflection module are sequentially disposed in the first optical axis direction.

3. The camera module of claim 2, wherein the first lens barrel and the second lens barrel are further configured to be movable relative to the reflection module in a direction perpendicular to a first optical axis, and
the second lens barrel is further configured to be movable relative to the first lens barrel and the reflection module in the first optical axis direction.

4. The camera module of claim 3, wherein the reflective member is configured to change a direction of light propagation from the first optical axis direction to a second optical axis direction, and
the second optical axis direction is different from the direction perpendicular to the first optical axis.

5. The camera module of claim 4, further comprising an image sensor module comprising an image sensor having an imaging plane,
wherein the image sensor module is disposed on the housing so that the imaging plane faces the reflective member and is oblique to the first optical axis direction.

6. The camera module of claim 5, wherein the image sensor module has a long side extending in a direction perpendicular to the optical axis direction and a short side perpendicular to the long side, and
a shortest distance from the first optical axis to one end of the short side of the image sensor module is shorter than a shortest distance from the first optical axis to another end of the short side of the image sensor module.

7. The camera module of claim 1, further comprising:
a first carrier on which the second lens barrel is disposed and configured to be movable in the first optical axis direction together with the second lens barrel; and
a second carrier on which the first lens barrel is disposed and configured to be movable in the direction perpendicular to the first optical axis together with the first lens barrel,
wherein the first carrier is disposed in the second carrier and is configured to move in the direction perpendicular to the first optical axis together with the second carrier.

8. The camera module of claim 7, further comprising a cover member to which the first lens barrel is coupled,
wherein the cover member is coupled to the second carrier so that the first lens barrel is disposed on an object side of the second lens barrel.

9. The camera module of claim 7, further comprising:
a first magnet disposed on the first carrier; and
a first coil disposed on the second carrier and facing the first magnet,
wherein the first magnet and the first coil are configured to generate a driving force in the first optical axis direction.

10. The camera module of claim 9, further comprising:
a second magnet and a third magnet disposed on the second carrier; and
a second coil disposed to face the second magnet and a third coil disposed to face the third magnet,
wherein the second coil and the third coil are disposed in the housing, and
the second magnet and the second coil are configured to generate a first driving force in a first direction perpendicular to the first optical axis, and the third magnet and the third coil are configured to generate a second driving force in a second direction perpendicular to the first optical axis.

11. The camera module of claim 10, further comprising:
a first substrate on which the first coil is disposed; and
a second substrate on which the second coil and the third coil are disposed,
wherein at least a portion of the first substrate is configured to move in the first direction perpendicular to the first optical axis together with the second carrier.

12. The camera module of claim 11, wherein the first substrate comprises:
a moving portion having the first coil mounted thereon and disposed on a side surface of the second carrier;
a connection portion disposed on a side surface of the housing parallel to the side surface of the second carrier on which the moving portion is disposed; and
an extending portion extending between the moving portion and the connection portion and comprising a curved portion.

13. A camera module comprising:
a housing having an internal space;
a lens module configured to be movable in at least one direction among a direction of a first optical axis and a direction perpendicular to the first optical axis;
a reflection module spaced apart from the lens module in the first optical axis direction and configured to change a direction of light incident on the reflection module in the first optical axis direction to a second optical axis direction; and
an image sensor module spaced apart from the reflection module in the second optical axis direction,
wherein the lens module is configured to move relative to the reflection module, and
the second optical axis direction is different from the direction perpendicular to the first optical axis.

14. The camera module of claim 13, wherein the lens module comprises:
a first lens barrel through which light enters the camera module; and
a second lens barrel disposed between the first lens barrel and the reflection module with a gap between the first lens barrel and the second lens barrel in the first optical axis direction.

15. The camera module of claim 14, wherein the second lens barrel is configured to move relative to the first lens barrel in the first optical axis direction, and is configured to move in the direction perpendicular to the first optical axis together with the first lens barrel.

16. The camera module of claim 13, wherein the reflection module is disposed on a bottom surface of the housing, and a portion of the reflection module overlaps the bottom surface of the housing in the first optical axis direction.
